(19) United States
(12) Patent Application Publication
(10) Pub. No.: US 2018/0225554 A1
(43) Pub. Date: Aug. 9, 2018

(54) SYSTEMS AND METHODS OF A COMPUTATIONAL FRAMEWORK FOR A DRIVER'S VISUAL ATTENTION USING A FULLY CONVOLUTIONAL ARCHITECTURE

(71) Applicant: HONDA MOTOR CO., LTD., Tokyo (JP)

(72) Inventors: Ashish TAWARI, Raymond, OH (US); Byeongkeun Kang, Raymond, OH (US)

(21) Appl. No.: 15/608,523

(22) Filed: May 30, 2017

Related U.S. Application Data
(60) Provisional application No. 62/455,328, filed on Feb. 6, 2017.

(51) Int. Cl. G06K 9/62; G05D 1/00

(52) U.S. Cl. CPC G06K 9/6278; G06K 9/70; G06K 9/624; G05D 1/0088

(57) ABSTRACT

Systems and methods for estimating a saliency of one or more targets of a drive scene are provided. In some aspects, the system includes a memory that stores instructions for executing processes for estimating the saliency of the one or more targets of the drive scene. The system further includes a processor configured to execute the instructions. In various aspects, the processes include generating a Bayesian framework to model visual attention of a driver, the Bayesian framework comprising a bottom-up saliency element and a top-down saliency element. In various aspects, the processes also include generating a fully convolutional neural network, based on the Bayesian framework, to generate a visual saliency model of the one or more targets in the driving scene. In further aspects, the processes include outputting the visual saliency model to indicate features that attract attention of the driver.

### CROSS-REFERENCE TO RELATED DISCLOSURES

This disclosure claims priority to Provisional Application No. 62/455,328, filed on Feb. 6, 2017, the contents of which are hereby incorporated in their entirety.

### TECHNICAL FIELD

The subject matter herein relates to methods and systems for estimating saliency in a drive scene.

### BACKGROUND

Interacting with traffic participants in a complex driving environment is a challenging and important task. Human vision systems may play a role to achieve this task. Particularly, visual attention mechanisms may allow a human driver to attend to salient and relevant regions of the scene to make decisions for driving. Investigative human vision systems may improve assistive and autonomous vehicular technology.

Among the most complex capabilities of a human driver may be the driver's ability to seamlessly perceive and interact with traffic participants in a complex driving environment. Human vision may play a role in perceiving the environment that then leads to an understanding of the scene and ultimately to suitable vehicle control behavior. Drivers may allocate their attention to the most important and salient regions or objects. However, to date, no computational framework exists that may accurately mimic a driver's gaze behavior and estimate saliency in a complex traffic driving environment. Nevertheless, traffic saliency detection, which computes the salient and relevant regions or targets in a specific driving environment, may be an important component of intelligent vehicle systems and may be useful in supporting autonomous driving, traffic sign detection, driving training, collision warning, and other tasks.

Visual attention, in general, refers to mechanisms that select important and relevant regions of a visual field to allow subsequent complex processing (e.g., object recognition) in real-time. Although modeling visual attention has been researched, existing theoretical and computational models attempt to explain eye movements (e.g., fixation/saccades), but they may not yet reliably mimic human gaze behavior in complex and naturalistic settings, such as driving. For example, visual attention may be conventionally guided by some combination of bottom-up and top-down mechanisms. Bottom-up cues may be influenced by external stimuli and are mainly based on characteristics of a visual scene, such as image-based conspicuities, whereas top-down cues are goal oriented where task, knowledge, memory, and expectations, among other factors guide gaze toward relevant/informative scene regions.

Bottom-up approaches may intuitively characterize some parts or events in the visual field that stand out from their neighboring background. For example, in the driving context, objects that pop out against the background due to high relative contrast, such as retroreflective traffic signs or events such as flashing indicators of a car, onset of tail brake light, etc., may be salient. Top-down approaches, on the other hand, are task-driven or goal-oriented. For example, subjects may be asked to watch the same scene under different tasks (e.g., analyzing different aspects of the same scene), and considerable differences in eye movement and fixations can be found based on the particular task being performed. This makes modeling of top-down attention conceptually challenging since different tasks may require different algorithms.

Driving generally occurs in a complex dynamic environment where different top-down factors evolving over time play a very active role in governing gaze behavior. Factors such as planning of a maneuver (e.g., turning left/right, taking the next exit, etc.), knowledge of traffic laws, expectation of finding other road participants in a given location, etc., may compete with bottom-up events and may greatly influence gaze behavior.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

The present disclosure is directed to a driver's gaze behavior to understand visual attention. According to aspects of the present disclosure, a Bayesian framework to model visual attention of a human driver is presented. Furthermore, based on the Bayesian framework, a fully convolutional neural network may be developed to estimate a salient region in a novel driving scene. According to further aspects of the present disclosure, a region in the scene that attracts a driver's attention may be investigated, where a driver's gaze provides a region of attention, leaving aside psychological effects such as in-attentional blindness, looked-but-did-not-see, etc. In this way, a driver's eye fixations in a real-world driving scene may be predicted. Towards this end, a Bayesian framework may be used to model visual attention of the driver and a fully convolutional neural network may be developed to predict gaze fixation and evaluate the performance of the system using on-road driving data.

In various aspects, the present disclosure may use the Bayesian framework to incorporate task dependent top-down and bottom-up factors in modeling a driver's visual attention. For example, visual saliency may be modeled using the fully convolutional neural network to predict a driver's gaze fixations, thorough evaluations and comparative studies may be performed using on-road driving data, and a top-down influence of different “tasks” as inferred from the vehicle state may be evaluated.

### BRIEF DESCRIPTION OF THE DRAWINGS

The novel features believed to be characteristic of aspects of the disclosure are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative aspects of the disclosure when read in conjunction with the accompanying drawings, wherein:

FIG. 1 illustrates a schematic view of an example operating environment of a data acquisition system in accordance with aspects of the present disclosure;

FIG. 2 illustrates an exemplary network for managing the data acquisition system;

FIG. 3 illustrates a vision systems, according to aspects of the present disclosure;

FIG. 4 illustrates images of location priors learned, according to aspects of the present disclosure;

FIG. 5A-5C illustrate images of gaze distributions, according to aspects of the present disclosure;

FIG. 6 illustrates a graph demonstrating saliency scores versus velocity, according to aspects of the present disclosure;

FIG. 7 illustrates a graph demonstrating results of the effects of location prior on the test sequence based on a yaw rate, according to aspects of the present disclosure;

FIG. 8 illustrates qualitative results of the systems and methods of the present disclosure along with the other methods, according to aspects of the present disclosure;

FIG. 9 illustrates various features of an example computer system for use in conjunction with aspects of the present disclosure; and

FIG. 10 illustrates a flowchart method of generating a saliency model, according to aspects of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

A “processor,” as used herein, processes signals and performs general computing and arithmetic functions. Signals processed by the processor may include digital signals, data signals, computer instructions, processor instructions, messages, a bit, a bit stream, or other computing that may be received, transmitted and/or detected.

A “bus,” as used herein, refers to an interconnected architecture that is operably connected to transfer data between computer components within a singular or multiple systems. The bus may be a memory bus, a memory controller, a peripheral bus, an external bus, a crossbar switch, and/or a local bus, among others. The bus may also be a vehicle bus that interconnects components inside a vehicle using protocols, such as Controller Area network (CAN), Local Interconnect Network (LIN), among others.

A “memory,” as used herein may include volatile memory and/or non-volatile memory. Non-volatile memory may include, for example, ROM (read only memory), PROM (programmable read only memory), EPROM (erasable PROM) and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and/or direct RAM bus RAM (DRRAM).

An “operable connection,” as used herein may include a connection by which entities are “operably connected”, is one in which signals, physical communications, and/or logical communications may be sent and/or received. An operable connection may include a physical interface, a data interface and/or an electrical interface.

A “vehicle,” as used herein, refers to any moving vehicle that is powered by any form of energy. A vehicle may carry human occupants or cargo. The term “vehicle” includes, but is not limited to: cars, trucks, vans, minivans, SUVs, motorcycles, scooters, boats, personal watercraft, and aircraft. In some cases, a motor vehicle includes one or more engines.

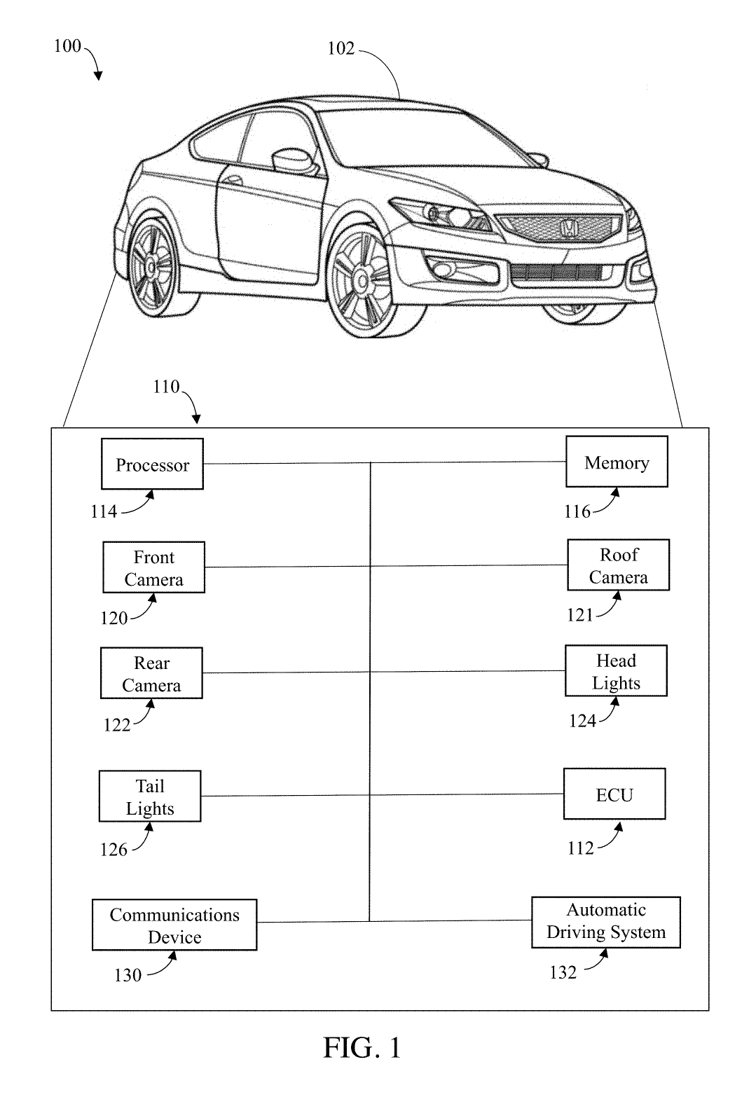

Generally described, the present disclosure provides systems and methods for estimating saliency in a drive scene. Turning to FIG. 1, a schematic view of an example operating environment 100 of a vehicle data acquisition system 110 according to an aspect of the disclosure is provided. The vehicle data acquisition system 110 may reside within a vehicle 102. The components of the vehicle data acquisition system 110, as well as the components of other systems, hardware architectures, and software architectures discussed herein, may be combined, omitted or organized into various implementations.

The vehicle 102 may generally include an electronic control unit (ECU) 112 that operably controls a plurality of vehicle systems. The vehicle systems may include, but are not limited to, the vehicle data acquisition system 110, among others, including vehicle HVAC systems, vehicle audio systems, vehicle video systems, vehicle infotainment systems, vehicle telephone systems, and the like. The data acquisition system 110 may include a front camera or other image-capturing device (e.g., a scanner) 120, roof camera or other image-capturing device (e.g., a scanner) 121, and rear camera or other image capturing device (e.g., a scanner) 122 that may also be connected to the ECU 112 to provide images of the environment surrounding the vehicle 102. The data acquisition system 110 may also include a processor 114 and a memory 116 that communicate with the front camera 120, roof camera 121, rear camera 122, head lights 124, tail lights 126, communications device 130, and automatic driving system 132.

The ECU 112 may include internal processing memory, an interface circuit, and bus lines for transferring data, sending commands, and communicating with the vehicle systems. The ECU 112 may include an internal processor and memory, not shown. The vehicle 102 may also include a bus for sending data internally among the various components of the vehicle data acquisition system 110.

The vehicle 102 may further include a communications device 130 (e.g., wireless modem) for providing wired or wireless computer communications utilizing various protocols to send/receive electronic signals internally with respect to features and systems within the vehicle 102 and with respect to external devices. These protocols may include a wireless system utilizing radio-frequency (RF) communications (e.g., IEEE 802.11 (Wi-Fi), IEEE 802.15.1 (Bluetooth®)), a near field communication system (NFC) (e.g., ISO 13157), a local area network (LAN), a wireless wide area network (WWAN) (e.g., cellular) and/or a point-to-point system. Additionally, the communications device 130 of the vehicle 102 may be operably connected for internal computer communication via a bus (e.g., a CAN or a LIN protocol bus) to facilitate data input and output between the electronic control unit 112 and vehicle features and systems. In an aspect, the communications device 130 may be configured for vehicle-to-vehicle (V2V) communications. For example, V2V communications may include wireless communications over a reserved frequency spectrum. As another example, V2V communications may include an ad hoc network between vehicles set up using Wi-Fi or Bluetooth®.

The vehicle 102 may include a front camera 120, a roof camera 121, and a rear camera 122. Each of the front camera 120, roof camera 121, and the rear camera 122 may be a digital camera capable of capturing one or more images or image streams, or may be another image capturing device, such as a scanner. The front camera 120 may be a dashboard camera configured to capture an image of an environment directly in front of the vehicle 102. The roof camera 121 may be a camera configured to broader view of the environment in front of the vehicle 102. The front camera 120, roof camera 121, and/or rear camera 122 may also provide the image to an automatic driving system 132, which may include a lane keeping assistance system, a collision warning system, or a fully autonomous driving system, among other systems.

The vehicle 102 may include head lights 124 and tail lights 126, which may include any conventional lights used on vehicles. The head lights 124 and tail lights 126 may be controlled by the vehicle data acquisition system 110 and/or ECU 112 for providing various notifications. For example, the head lights 124 and tail lights 126 may assist with scanning an identifier from a vehicle parked in tandem with the vehicle 102. For example, the head lights 124 and/or tail lights 126 may be activated or controlled to provide desirable lighting when scanning the environment of the vehicle 102. The head lights 124 and tail lights 126 may also provide information such as an acknowledgment of a remote command (e.g., a move request) by flashing.

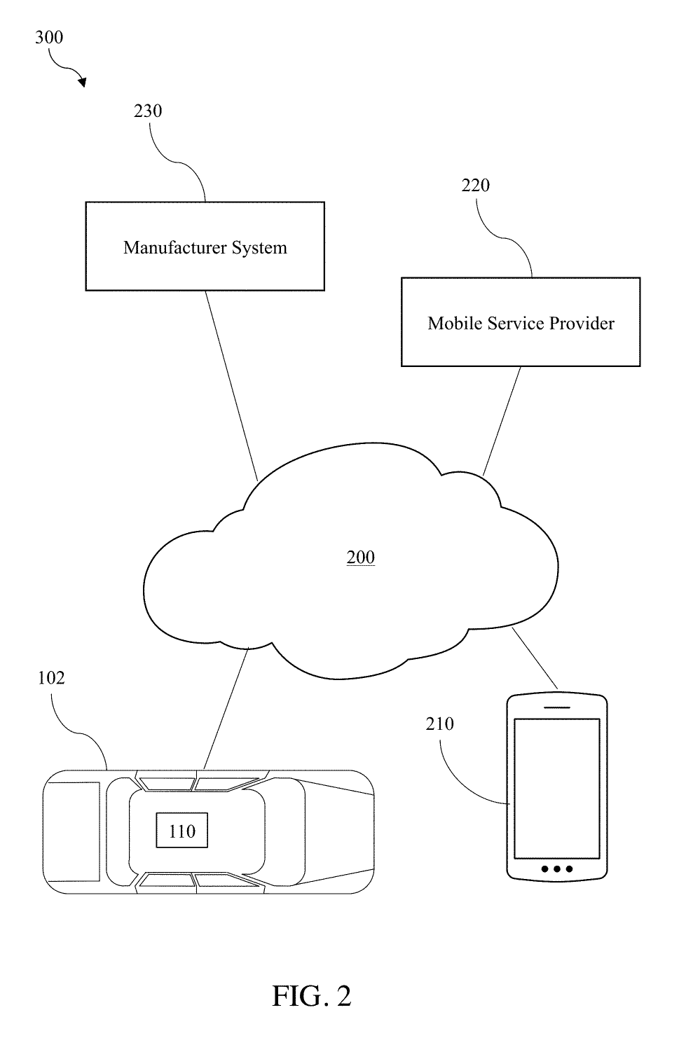

FIG. 2 illustrates an exemplary network 200 for managing the data acquisition system 110. The network 200 may be a communications network that facilitates communications between multiple systems. For example, the network 200 may include the Internet or another internet protocol (IP) based network. The network 200 may enable the data acquisition system 110 to communicate with a mobile device 210, a mobile service provider 220, or a manufacturer system 230.

The data acquisition system 110 within the vehicle 102 may communicate with the network 200 via the communications device 130. The data acquisition 110 may, for example, transmit images captured by the front camera 120, roof camera 121, and/or the rear camera 122 to the manufacturer system 230. The data acquisition system 110 may also receive a notification from another vehicle or from the manufacturer system 230.

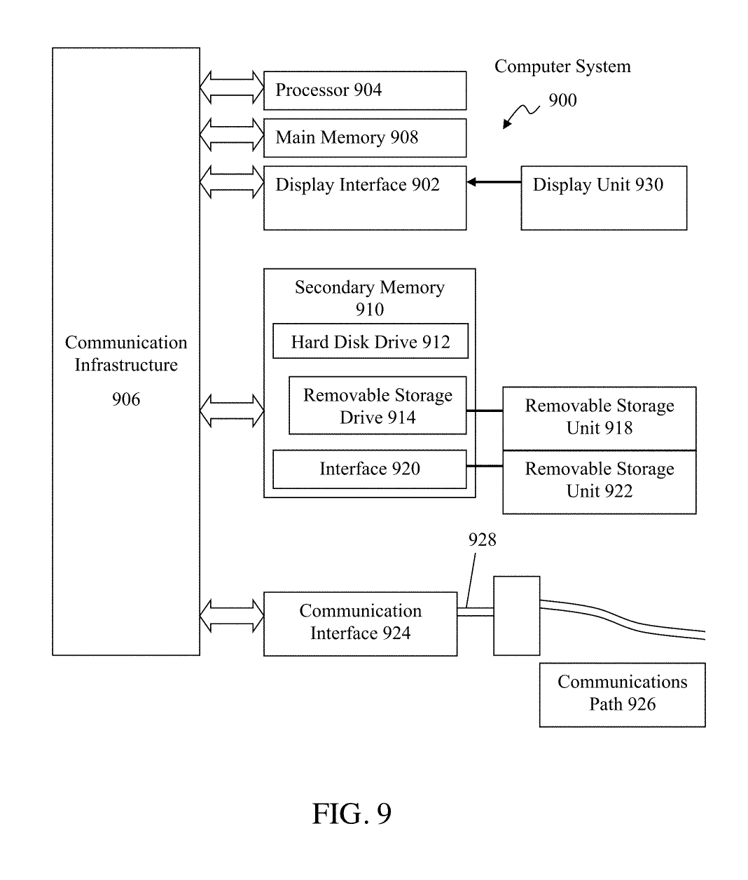

The manufacturer system 230 may include a computer system, as shown with respect to FIG. 9 described below, associated with one or more vehicle manufacturers or dealers. The manufacturer system 230 may include one or more databases that store data collected by the front camera 120, roof camera 121, and/or the rear camera 122. The manufacturer system 230 may also include a memory that stores instructions for executing processes for estimating saliency of the one or more targets of a drive scene of the vehicle 102 and a processor configured to execute the instructions.

According to aspects of the present disclosure, the manufacturer system 230 may be configured to determine a saliency of a drive scene. In some aspects, saliency may be represented as s_{z}=p(O=1|F=f_{z}, L=l_{z}), where z may be a point in the visual field of the driver. A point may be a pixel in the scene camera frame, f_{z} and l_{z} may represent visual features and location (x, y) of the point z, and O may be a binary variable, where O=1 may represent the presence of objects/regions (also referred to as targets) relevant for driving. Thus, in various aspects, the higher the probability of the relevant targets at the point z, the more salient the point z may become.

Driving generally occurs in a highly dynamic environment that includes different tasks at different points in time, for example, car following, lane keeping, turning, changing lane, etc. The same driving scene with different tasks in mind may influence the gaze behavior of a driver. Such influences due to the different tasks may be modeled in accordance with various aspects of the present disclosure. For example, in some aspects, these influences may be modeled, by the manufacturer system 230, using equation (1) below, where T may be a discrete random variable drawn from the space of all tasks, Tϵ [symbol] ={T₁, T₁, . . . Tₙ}

$$\begin{matrix}{s}_{z} = {\sum }_{{T}_{i}} p ( O = 1 , 𝒯 = {T}_{i} \vert F = {f}_{z} , L = {l}_{z} ) \\ = {\sum }_{{T}_{i}} \underbrace{p ( O = 1 \vert {f}_{z} , {l}_{z} , {T}_{i} )}_{{S}_{z} ( {T}_{i} )} p ( {T}_{i} )\end{matrix} \qquad ( 1 )$$

Looking closer at the first component of the right-hand side (abbreviated as S_{z}(Tᵢ) due to the space constraint) of equation (1), using Bayes rule:

$$\begin{matrix}{S}_{z} ( {T}_{i} ) = p ( O = 1 \vert {f}_{z} , {l}_{z} , {T}_{i} ) \\ = \frac{p ( {f}_{z} , {l}_{z} \vert O = 1 , {T}_{i} ) p ( O = 1 \vert {T}_{i} )}{p ( {f}_{z} , {l}_{z} \vert {T}_{i} )}\end{matrix} \qquad ( 2 )$$

In some aspects, equation (2) may be simplified when the features and the locations of point z are considered conditionally independent. In other words, a feature's distribution may not change with location across a scene regardless of whether or not it appears on the target during any given task. As such, equation (2) may be decomposed into meaningful components as illustrated in equation (3) below, where for simplicity, O=1 may be abbreviated as O:

$$\begin{matrix}S = \frac{p ( {f}_{z} , {l}_{z} \vert O , {T}_{i} ) p ( O \vert {T}_{i} )}{p ( {f}_{z} , {l}_{z} \vert {T}_{i} )} \\ \approx \frac{p ( {f}_{z} \vert O , {T}_{i} ) p ( {l}_{z} \vert O , {T}_{i} ) p ( O \vert {T}_{i} )}{p ( {f}_{z} \vert {T}_{i} ) p ( {l}_{z} \vert {T}_{i} )} \\ = \frac{1}{p ( {f}_{z} \vert {T}_{i} )} p ( {f}_{z} \vert O , l , {T}_{i} ) \frac{p ( {l}_{z} \vert O , {T}_{i} ) p ( O \vert {T}_{i} )}{p ( {l}_{z} \vert {T}_{i} )} \\ = \frac{1}{\underbrace{p ( {f}_{z} \vert {T}_{i} )}_{{ Bottom \text{-} up }_{Saliency}}} \underbrace{p ( {f}_{z} \vert O , {T}_{i} ) p ( O \vert {l}_{z} , {T}_{i} )}_{{ Top \text{-} down }_{knowledge}}\end{matrix} \qquad ( 3 )$$

In various aspects, the first component of equation (3) may be referred to as bottom-up saliency as it does not depend on the target. In some aspects, as the feature of the point z becomes less probable, the more salient point z may become. In other words, features that are rare may be salient. In various aspects, the second component of equation (3) may depend on target and related knowledge, and as such, may be referred to as top-down saliency. Thus, in some aspects, a first part of the second component may encourage features that are found in targets. That is, features that are important may be salient. In further aspects of the present disclosure, a second part of the second component may encode knowledge of targets' expected location, may be referred to as a location prior. From a driving perspective, this may entail the driver developing prior expectation of relevant targets in a particular location of the scene, while executing a particular task, such as checking a side mirror or looking over shoulder while changing lanes.

In various aspects, accurately learning the high dimensional feature distribution as in p(f_{z}|Tᵢ) and p(f_{z}|O, Tᵢ) may be difficult, and as such, the first two terms in the equation (3) may be rearranged using Bayes rule as follows:

$$\begin{matrix}S = \frac{1}{p ( {f}_{z} \vert {T}_{i} )} p ( {f}_{z} \vert O , {T}_{i} ) p ( O \vert {l}_{z} , {T}_{i} ) \\ = \frac{p ( {f}_{z} , O \vert {T}_{i} )}{p ( O \vert {T}_{i} ) p ( {f}_{z} \vert {T}_{i} )} p ( O \vert {l}_{z} , {T}_{i} ) \\ = p ( O \vert {f}_{z} , {T}_{i} ) p ( O \vert {l}_{z} , {T}_{i} ) {p ( O \vert {T}_{i} )}^{- 1}\end{matrix} \qquad ( 4 )$$

In aspects of the present disclosure, the last term of equation (4), p(O|Tᵢ) may be the prior probability of the target class given a particular task, and may be considered to be uniform (e.g., a constant value).

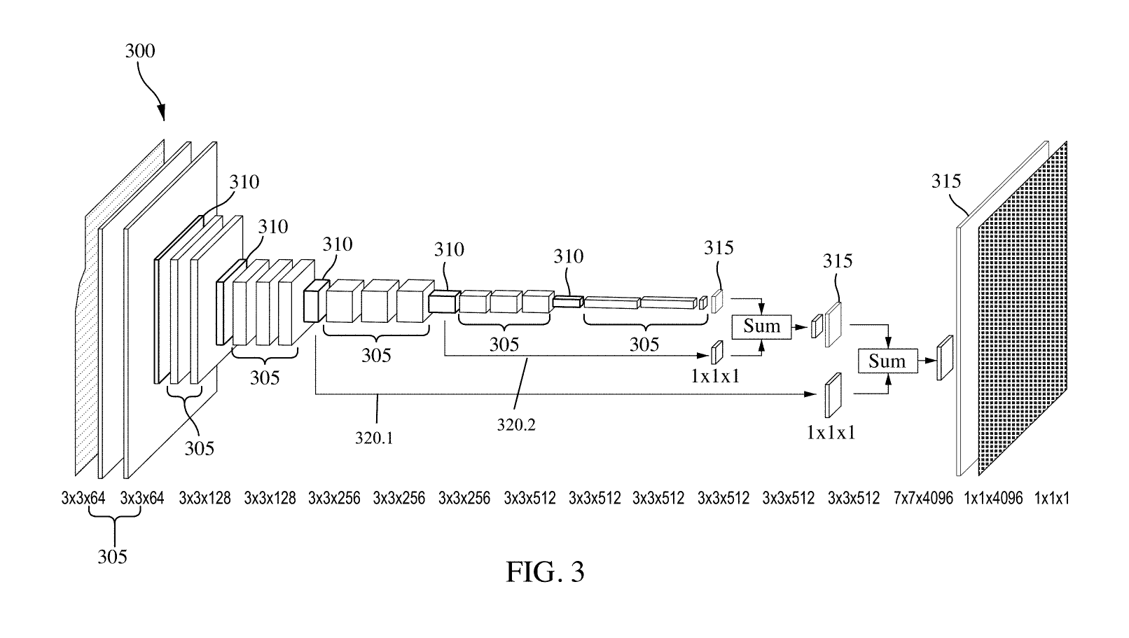

FIG. 3 illustrates an architecture 300 of the manufacturer system 230 according to aspects of the present disclosure. In various aspects, a plurality of first hexahedrons 305, a plurality of second hexahedrons 310, and a plurality of third hexahedrons 315 may represent a convolution layer, a pooling layer, and a deconvolution layer, respectively. As illustrated in FIG. 3, numbers related to each of the plurality of first hexahedrons 305 illustrate a kernel size of each of the plurality of first hexahedrons 305 in sequence. In some aspects, a kernel size of each of the a plurality of second hexahedrons 310 may be 2×2. Furthermore, in some aspects, strides of each of the plurality of first hexahedrons 305 and the plurality of second hexahedrons 310, e.g., the convolution layers and pooling layers, respectively, may be 1 and 2, respectively. In other aspects, a front two of the plurality of third hexahedrons 315 may be a kernel size of 4×4×1 and stride of 2, and a last one of the plurality of third hexahedrons 315 may be a kernel size of 16×16×1 and stride of 8. Thus, in various aspects of the present disclosure, the overall saliency from Equation 1 may be:

$${s}_{z} ∝ {\sum }_{{T}_{i}} p ( O \vert {f}_{z} , {T}_{i} ) p ( O \vert {l}_{z} , {T}_{i} ) p ( {T}_{i} ) \\ {s}_{z} = \frac{1}{Z} {\sum }_{{T}_{i}} p ( O \vert {f}_{z} , {T}_{i} ) p ( O \vert {l}_{z} , {T}_{i} ) p ( {T}_{i} ) \qquad ( 5 )$$

where Z may be a normalizing factor. In various aspects, factors p(O|f_{z}, Tᵢ) and p(O|l_{z}, Tᵢ) may be learned from driving data. For example, p(O|f_{z}, Tᵢ) may be modeled using a fully convolutional neural network and p(O|l_{z}, Tᵢ) may be learned from the location prior for each task.

In aspects of the present disclosure, salient regions may be modulated, for example by the manufacturer system 230, with the weights estimated based on the learned prior distribution. In various aspects, modeling p(O|f_{z}, Tᵢ) may be based on the weights for a feature vector in a given “task” Tᵢ to discriminate between the target classes, i.e., salient versus not-salient targets. In some aspects, for driving data, a longer fixation at a point may be interpreted as receiving more attention to the point by the driver, and hence may be more salient. Thus, saliency may be modeled as a pixel-wise regression problem.

In further aspects, local conspicuity features of saliency may require an analysis of surrounding background. In other words, local features are not analyzed independently but in connection with the surrounding features. In some aspects, this may be achieved by skip connections 320.1, 320.2 (collectively skip connections 320). For example, the skip connection 320.1 may connect a first one of the plurality of second hexahedrons 310 to a first one of the plurality of first hexahedrons 305, and the skip connection 320.2 may connect a second one of the plurality of second hexahedrons 310 to a second one of the of the plurality of first hexahedrons 305. The skip connections 320 may allow an early feature response to directly interact with a later feature response, which often works with a down-sampled version (e.g., due to an intermediate max-pool layer) of earlier maps, and hence may cover a bigger area around a pixel in the original input frame for the same receptive field size.

In various aspects, saliency datasets may reveal a strong center bias of human eye fixation for free viewing image and video frames, e.g., using a Gaussian blob centered in the middle of the image frame as the saliency map. From the driving data perspective, a driver may pay attention in the front for most of the time, and therefore, the manufacturer system 230 of the present disclosure may be configured to avoid learning trivial center-bias solution.

Based on the above criteria, in some aspects, the manufacturer system 230 may include a convolutional neural network (CNN), e.g. a fully convolutional neural network (FCN). In some aspects, a fully convolutional neural network may take an input of an arbitrary size and may produce correspondingly-sized output. Furthermore, a fully convolutional network (with no fully connected layer) may treat the image pixel identically irrespective of its location. That is, in some aspects, as long as a receptive field of the fully convolutional layers is not too big to cause edge effects (e.g., when the receptive field size is same as the size of input layer), the fully convolutional network of the manufacturer system 230 does not have any way to exploit location information.

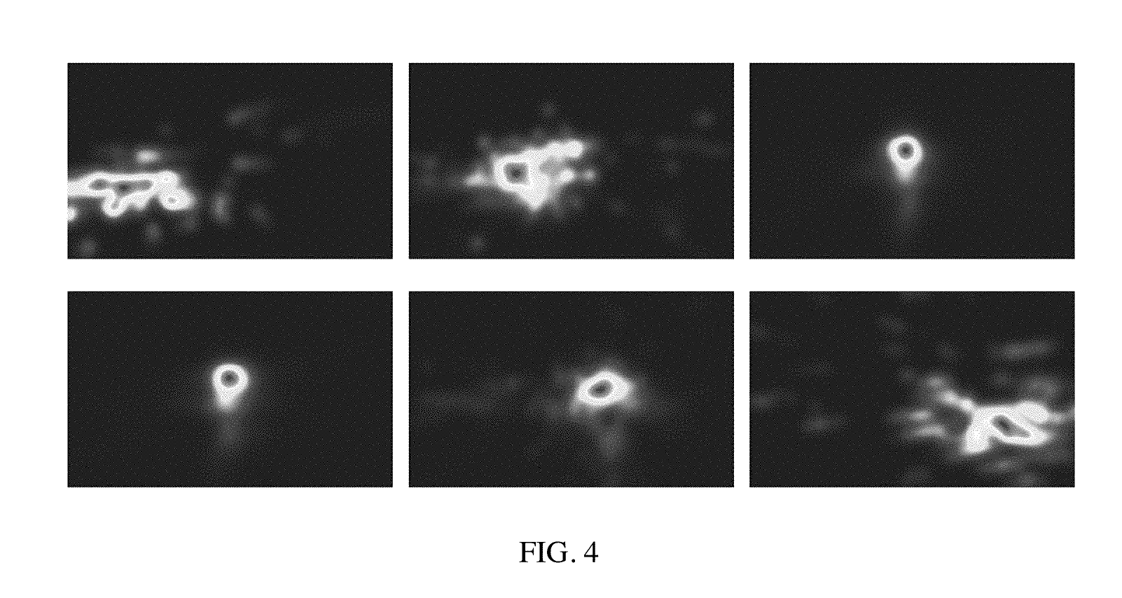

FIG. 4 illustrates location-priors learned for different “tasks” as inferred from a yaw rate. Namely, as shown in FIG. 4, the top and bottom rows show effects of negative yaw rate (turning-left) and positive yaw rate (turning-right), respectively. Additionally, FIG. 4 illustrates that as the magnitude of yaw rate increases, location prior shifts away from the center. In various aspects of the present disclosure, because the saliency estimation task may be considered as a pixel-wise regression problem, the fully convolutional network of the manufacturer system 230 may be adapted for such a regression problem. For example, in some aspects, a FCN-8 (Fully Convolutional Network) architecture may be deployed that has multiple skip connections with minor modifications, such as changing score layers to reflect single channel saliency score and loss layer for regression. In some expects, for loss function, L2 loss L may be defined as follows:

$$L = \frac{1}{2 N} {\sum }_{n = 1}^{N} {‖ {\hat{y}}_{n} - {y}_{n} ‖}_{2}^{2} \qquad ( 6 )$$

where N may be the total number of data, ŷ may be the estimated saliency, and y may be the targeted saliency.

In various aspects, a fixed deconvolutional layer with a bilinear up-sampled filter weight may be used as one of the straining strategies. In further aspects, the present disclosure may be initialized using the fully convolutional network (e.g., FCN-8) that may be trained using segmentation datasets, and may be trained for saliency estimation task using a DR(eye)VE training datasets of the manufacturer system 230. For example, the DR(eye)VE datasets may include 74 sequences of 5 minutes each, and may provide videos from the front camera 120, the roof camera 121, the rear camera 122, a head mounted camera, a captured gaze location from a wearable eye tracking device, and/or other information from Global Positioning System (GPS) related to the vehicle status (e.g., speed, course, latitude, longitude, etc.). The captured gaze pixel location may be further processed using a spatio-temporal Gaussian model G(σₛ, σₜ), with σₛ=200 pixels and σₜ=k/2, where k=25 frames, to acquire the smoothed ground truth saliency map. In some aspects, the DR(eye)VE datasets may be collected from a plurality of drivers, in different areas (e.g., downtown, countryside, and highway), under different weather conditions (e.g., sunny, cloudy, and rainy), and at different times of the day (e.g., morning, evening, and night). In various aspects, the DR(eye)VE datasets may be separated for training and testing (e.g., the first 37 sequences for the training and the last 37 sequences for the testing). In some aspects, frames with errors may be excluded. In further aspects, for training, any frame when the vehicle is stationary may also be excluded because generally when the vehicle is not moving, the driver is not expected to be attentive to driving related events.

As discussed herein, during driving, tasks such as lane changing, turning left/right, exiting highways, etc., may influence top-down attention. As such, the probability distributions p(O|f_{z}, Tᵢ) and p(O|l_{z}, Tᵢ) may be conditioned upon these tasks, and in some aspects of the present disclosure, these distributions may be learned from a portion of DR(eye)VE datasets when the driver is engaged in such tasks. In some aspects, the DR(eye)VE datasets lack such task information currently, and as such, these “tasks” may be defined based on vehicle dynamics. For example, the DR(eye)VE datasets may be divided based on the yaw rate. In some aspects, the yaw rate may be indicative of events, for example, turns (right/left), exiting, curve-following, etc., and may provide a reasonable and an automatic way to infer task contexts. In various aspects, in the datasets, the yaw rate may be computed from the course measurement provided by the GPS.

In some aspects, the DR(eye)VE datasets may be divided into discrete intervals of yaw rate with a bin size of 5°/sec. Then the location-prior, p(O|l_{z}, Tᵢ), may be calculated as the average of all the training set attentional maps within a bin. As discussed herein, FIG. 4 shows yaw rate effects on the estimation of location prior. For example, as the yaw rate magnitude increases, the location prior becomes more and more skewed towards the edges (e.g., away from the center). Also, in some aspects, the positive yaw rate (turning-right events) shifts the location prior towards the right of the center and the opposite for the negative yaw rate (turning-left events).

In further aspects, learning p(O|f_{z}, Tᵢ) may be achieved by training the neural network. However, as the yaw rate magnitude increases, the dataset size for training within a bin may dramatically decrease. To resolve this, p(O|f_{z}, Tᵢ) to p(O|f_{z}) may be approximated by taking all the data for this component. For example, for quantitative analysis, a linear correlation coefficient (CC) (also known as Pearson's linear coefficient) between estimated saliency map and ground truth saliency map may be computed. In some aspects, each saliency map s may be normalized as follows:

s′_{z}(s_{z}−s̅)/σ(s) (7)

where s̅ may represent a mean of saliency map s, and σ(s) may be a standard deviation of s, and z may be the pixel in the scene camera frame. Then, CC may be computed as follow:

$$CC = \frac{{\sum }_{z} ( {s}_{z}^{′} - \overline{{s}^{′}} ) ( \hat{{s}_{z}^{′}} - {{s}^{′}}^{\overline{\hat{}}} )}{\sqrt{( {\sum }_{z} {( {s}_{z}^{′} - \overline{{s}^{′}} )}^{2} ) ( {\sum }_{z} {( \hat{{s}_{z}^{′}} - {{s}^{′}}^{\overline{\hat{}}} )}^{2} )}} \qquad ( 8 )$$

where s′ may represent normalized ground truth saliency map, and ŝ′ may be a normalized estimated saliency map.

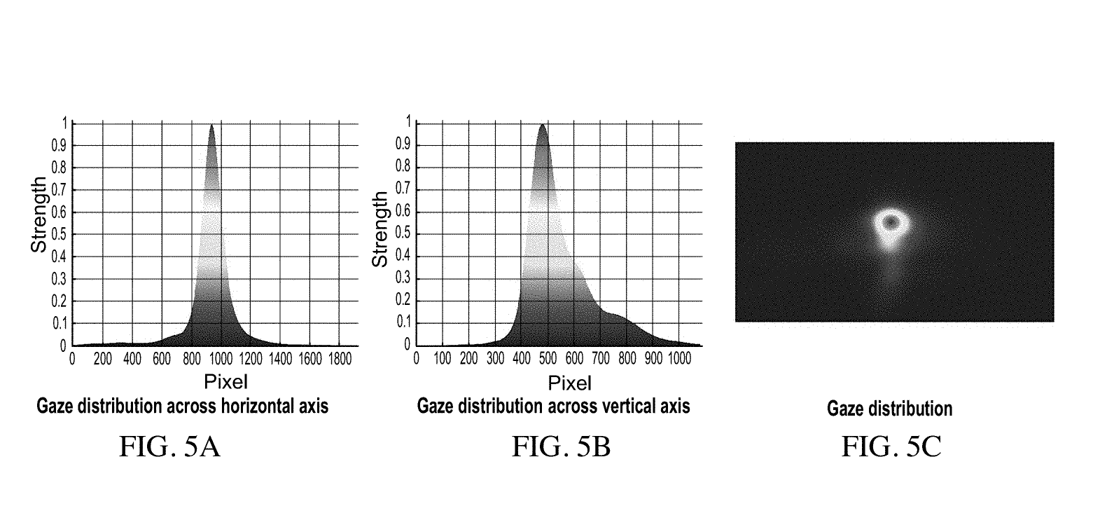

FIG. 5A-5C illustrate images of gaze distributions. In some aspects, FIGS. 5A-5C illustrate a center-bias-filter learned from the mean ground truth eye fixations. In some aspects, a gaze distribution across a horizontal axis, as shown in FIG. 5A, and across a vertical axis, as shown in FIG. 5B, may be learned. Furthermore, FIG. 5C illustrates an overall gaze distribution. In some aspects, for a baseline, the performance with the center-bias-filter may be computed. This baseline may be used as a comparison for the performance of the systems and methods discussed herein. Table I shows the performance of the proposed method. Namely, Table I illustrates test results obtained by the baseline, traditional bottom-up saliency methods, and the approach of the present disclosure, where results in the parenthesis were obtained by incorporating the learned location priors.

TABLE I

| Baseline- | Itti | Image Signature | GBVS | DR(EYE)VE | Proposed |
|---|---|---|---|---|---|
| Center | [26] | [27] | [28] | [29] | Approach |
| 0.47 ± 0.24 | 0.16 ± 0.10 | 0.14 ± 0.12 | 0.20 ± 0.10 | 0.55 ± 0.28 | 0.55 ± 0.28 |
| | | | | | (0.55 ± 0.28) |

Overall, the systems and methods of the present disclosure achieve about a 0.55 score. The traditional methods, on the other hand, show no correlation (CC<0.3), and the baseline results, which correspond to a simple top-down cues, perform better. Thus, the systems and methods of the present disclosure outperform the baseline as well as the traditional approaches. In some aspects, the systems and methods of the present disclosure achieve the state-of-the-art results using a single frame to predict fixation region, as opposed to a sequence of frames, and hence, computationally may be much more efficient.

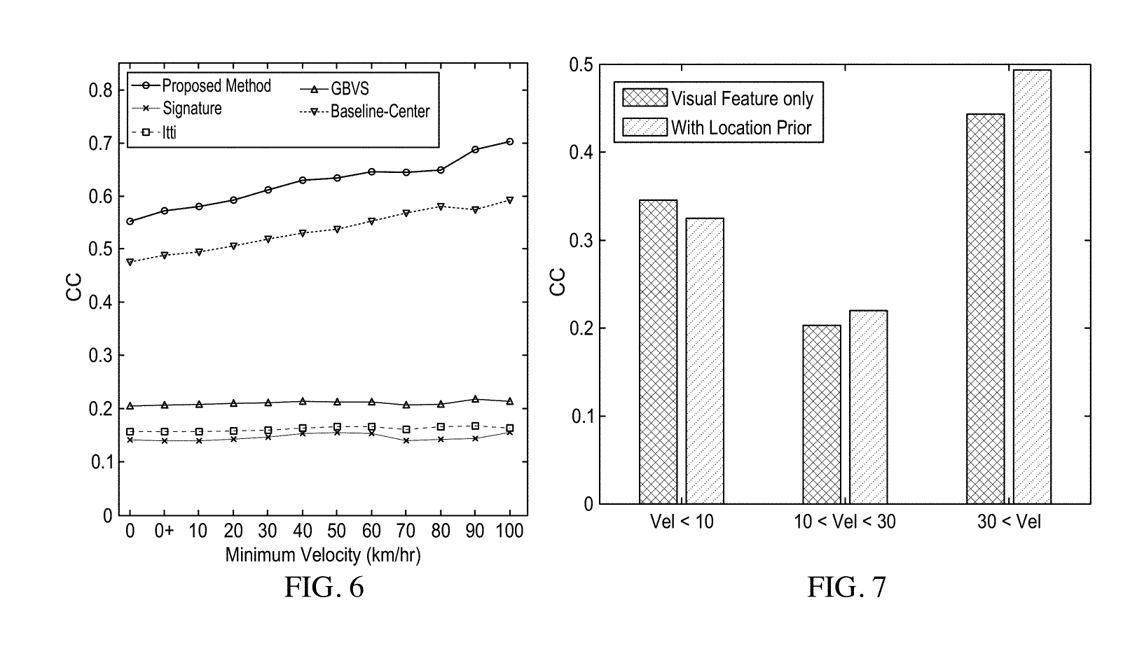

FIG. 6 illustrates a graph comparing a saliency score versus velocity. As shown in FIG. 6, each point may present the average correlation coefficient of the frames with velocity greater than a given velocity. As further shown in FIG. 6, as the velocity increases, the performance of the systems and methods of the present disclosure improve with a correlation coefficient being approximately 0.70 for velocity greater than 100 km/h. This occurs because a driver may be naturally more focused and less distracted by other unrelated events while driving at a high speed, and tends to constantly follow road features like lane markings, which are very well captured by the learned network, according to aspects of the present disclosure. In still further aspects, excluding frames when the vehicle is stationary may further improve performance by approximately 5%. This may be attributed to the fact that when the vehicle is not moving, drivers may look around freely to non-driving events.

FIG. 7 illustrates test results of effects of location prior on the test sequence with yaw rate>15°/sec. For example, FIG. 7 illustrates test results for a velocity less than 10 km/h, test results for a velocity between 10 km/h and 30 km/h, and a velocity greater than 30 km/h. Notably, as illustrated in FIG. 7, in cases where yaw rate is greater than 15°/sec and with a velocity greater than 30 km/h, a 10% improvement over using visual feature only may be achieved. These are in fact situations where a driver may be actively involved in maneuvers such as turns (left/right) and exits.

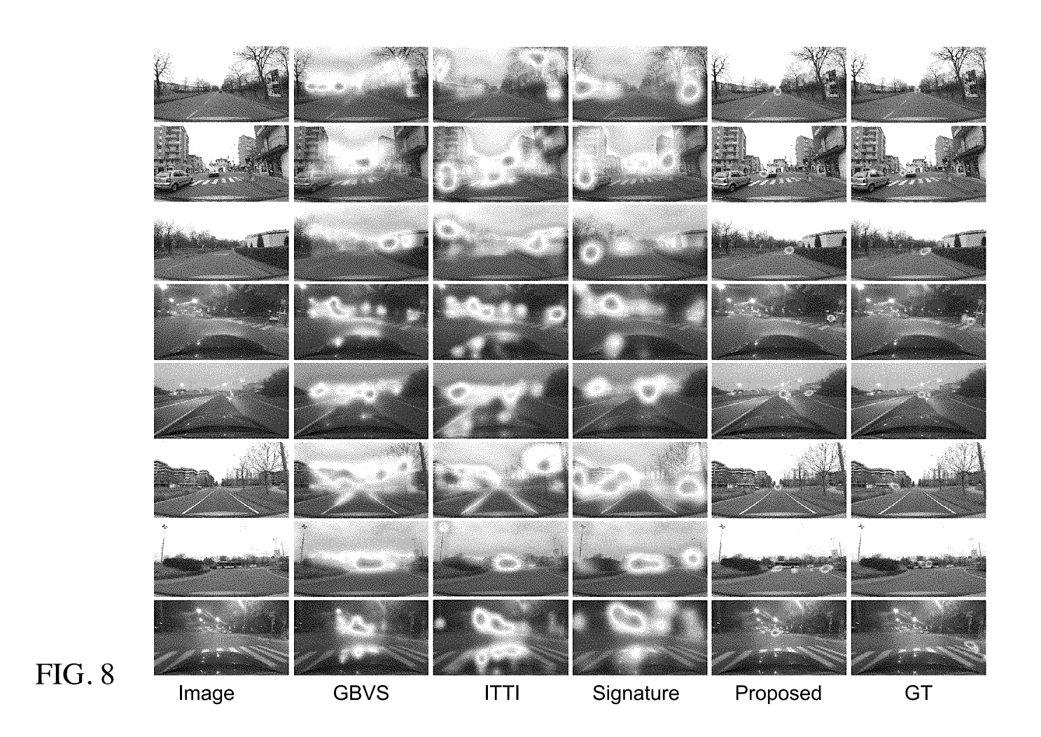

A closer look at the network's output shows that the systems and methods of the present disclosure may respond well to road features that attract a driver's attention, as illustrated in FIG. 8, which illustrates qualitative results according to aspects of the present disclosure, along with methods based on GBVS, ITTI, and Image Signature for a driver's eye fixation prediction during different “tasks.” Additionally, the “GT” column of FIG. 8 shows a ground truth fixation map (GT). As shown in FIG. 8, a vanishing point of the lane markings affects the driver's gaze behavior, and the systems and methods of the present disclosure may learn those meaningful representations. From the gaze data, it is clear that the current “task” during driving may be an important factor. For example, whether the driver is planning to take the imminent exist or not will influence his/her gaze behavior (row 5 from top in FIG. 8). From a visual feature alone, such factors cannot be incorporated to mimic the gaze behavior, and as such, the systems and methods of the present disclosure may model such task-oriented expectations using location prior. In general, any information independent of visual features may be incorporated as prior information and learned from the data.

Aspects of the present invention may be implemented using hardware, software, or a combination thereof and may be implemented in one or more computer systems or other processing systems. In an aspect of the present invention, features are directed toward one or more computer systems capable of carrying out the functionality described herein. An example of such a computer system 900 is shown in FIG. 9.

Computer system 900 includes one or more processors, such as processor 904. The processor 904 is connected to a communication infrastructure 906 (e.g., a communications bus, cross-over bar, or network). Various software aspects are described in terms of this example computer system. After reading this description, it will become apparent to a person skilled in the relevant art(s) how to implement aspects of the invention using other computer systems and/or architectures.

Computer system 900 may include a display interface 902 that forwards graphics, text, and other data from the communication infrastructure 906 (or from a frame buffer not shown) for display on a display unit 930. Computer system 900 also includes a main memory 908, preferably random access memory (RAM), and may also include a secondary memory 910. The secondary memory 910 may include, for example, a hard disk drive 912, and/or a removable storage drive 914, representing a floppy disk drive, a magnetic tape drive, an optical disk drive, a universal serial bus (USB) flash drive, etc. The removable storage drive 914 reads from and/or writes to a removable storage unit 918 in a well-known manner. Removable storage unit 918 represents a floppy disk, magnetic tape, optical disk, USB flash drive etc., which is read by and written to removable storage drive 914. As will be appreciated, the removable storage unit 918 includes a computer usable storage medium having stored therein computer software and/or data.

Alternative aspects of the present invention may include secondary memory 910 and may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 918, a hard disk installed in hard disk drive 912, and signals 928. These computer program products provide software to the computer system 900. Aspects of the present invention are directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features in accordance with aspects of the present invention, as discussed herein. In particular, the computer programs, when executed, enable the processor 904 to perform the features in accordance with aspects of the present invention. Accordingly, such computer programs represent controllers of the computer system 900.

In an aspect of the present invention where the invention is implemented using software, the software may be stored in a computer program product and loaded into computer system 900 using removable storage drive 914, hard drive 912, or communications interface 920. The control logic (software), when executed by the processor 904, causes the processor 904 to perform the functions described herein. In another aspect of the present invention, the system is implemented primarily in hardware using, for example, hardware components, such as application specific integrated circuits (ASICs). Implementation of the hardware state machine so as to perform the functions described herein will be apparent to persons skilled in the relevant art(s).

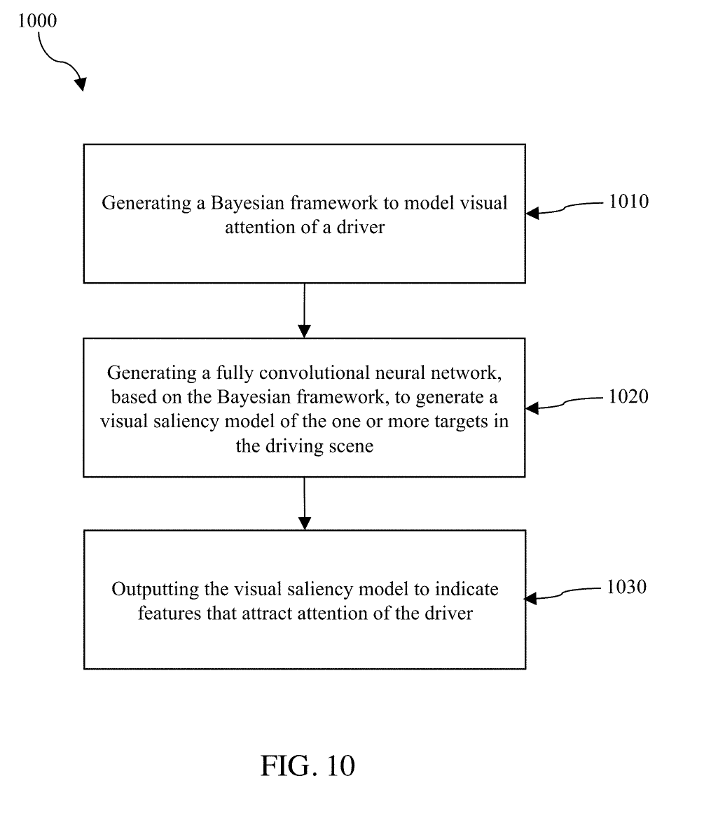

FIG. 10 illustrates a flowchart method of generating a saliency model, according to aspects of the present disclosure. A method 1000 of generating a saliency model includes generating a Bayesian framework to model visual attention of a driver 1010, generating a fully convolutional neural network, based on the Bayesian framework, to generate a visual saliency model of the one or more targets in the driving scene 1020, and outputting the visual saliency model to indicate features that attract attention of the driver 1030.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. An automated driving (AD) system for estimating a saliency of one or more targets of a drive scene, the system comprising:
a memory that stores instructions for executing processes for estimating the saliency of the one or more targets of the drive scene; and
a processor configured to execute the instructions, wherein the processes comprise:
generating a Bayesian framework to model visual attention of a driver, the Bayesian framework comprising a bottom-up saliency element and a top-down saliency element;
generating a fully convolutional neural network, based on the Bayesian framework, to generate a visual saliency model of the one or more targets in the driving scene; and
outputting the visual saliency model to indicate features that attract attention of the driver.

2. The AD system of claim 1, wherein:
the bottom-up saliency element is target independent; and
the top-down saliency element is target dependent.

3. The AD system of claim 2, wherein the top-down saliency element comprises a first component that indicates that important targets are salient and a second component that indicates knowledge of an expected location of a target.

4. The AD system of claim 3, wherein the expected location of the target is based on a yaw rate, wherein as a magnitude of the yaw rate increases, the expected location of the target shifts away from a center field of view.

5. The AD system of claim 1, wherein the processes further comprise modulating one or more salient regions of the driving scene with weights estimated based on a learned prior distribution.

6. The AD system of claim 5, wherein the weights are based on a task of the one or more targets.

7. The AD system of claim 1, wherein the fully convolutional neural network comprises one or more skip connections configured to enable the fully convolutional neural network to analyze the one or more targets in connection with surrounding features of the one or more targets.

8. A method for estimating a saliency of one or more targets of a drive scene, the method comprising:
generating a Bayesian framework to model visual attention of a driver, the Bayesian framework comprising a bottom-up saliency element and a top-down saliency element;
generating a fully convolutional neural network, based on the Bayesian framework, to generate a visual saliency model of the one or more targets in the driving scene; and
outputting the visual saliency model to indicate features that attract attention of the driver.

9. The method of claim 8, wherein:
the bottom-up saliency element is target independent; and
the top-down saliency element is target dependent.

10. The method of claim 9, wherein the top-down saliency element comprises a first component that indicates that important targets are salient and a second component that indicates an expected location of a target, wherein the expected location is based on previous driver experience.

11. The method of claim 10, wherein the expected location of the target is based on a yaw rate.

12. The method of claim 8, further comprising modulating one or more salient regions of the driving scene with weights estimated based on a learned prior distribution.

13. The method of claim 12, wherein the weights are based on a task of the one or more targets.

14. The method of claim 8, further comprising analyzing the one or more targets in connection with surrounding features of the one or more targets based on one or more skip connections of the fully convolutional neural network.

15. A non-transitory computer-readable storage medium containing executable computer program code, the code comprising instructions configured to:
generate a Bayesian framework to model visual attention of a driver, the Bayesian framework comprising a bottom-up saliency element and a top-down saliency element;
generate a fully convolutional neural network, based on the Bayesian framework, to generate a visual saliency model of the one or more targets in the driving scene; and
output the visual saliency model to indicate features that attract attention of the driver.

16. The non-transitory computer-readable storage medium of claim 15, wherein:
the bottom-up saliency element is target independent; and
the top-down saliency element is target dependent.

17. The non-transitory computer-readable storage medium of claim 15, wherein the top-down saliency element comprises a first component that indicates that important targets are salient and a second component that indicates an expected location of a target, wherein the expected location is based on previous driver experience.

18. The non-transitory computer-readable storage medium of claim 17, wherein the expected location of the target is based on a yaw rate.

19. The non-transitory computer-readable storage medium of claim 15, wherein the code comprising instructions further configured to modulate one or more salient regions of the driving scene with weights estimated based on a learned prior distribution.

20. The non-transitory computer-readable storage medium of claim 12, wherein the weights are based on a task of the one or more targets.
